(19) United States
(12) Patent Application Publication
(10) Pub. No.: US 2008/0291260 A1
(43) Pub. Date: Nov. 27, 2008

(54) Portable video conferencing device

(76) Inventors: John Dignan, Mussey Township, MI (US); Simon Palushaj, Shelby Township, MI (US)

Correspondence Address: Thomas E. Bejin;RADER, FISHMAN & GRAUER PLLC, Suite 140, 39533 Woodward Avenue, Bloomfield Hills, MI, 48304, US

(21) Appl. No.: 11/805,633

(22) Filed: May 24, 2007

(51) Int. Cl. H04N 7/14

(52) U.S. Cl. 348/14.02; 348/E07.083

(57) ABSTRACT

A portable video conferencing device includes a mobile computing device and an audio input device, a video camera, and at least one wireless radio chipset electrically linked to the mobile computing device. The video camera provides a video output stream and can execute commands received at the portable video conferencing device from a remote device.

### TECHNICAL FIELD

The field of this invention relates to a wireless communication devices, and particularly to portable video conferencing devices.

### BACKGROUND OF THE DISCLOSURE

Telecommunication systems have been used for many years, enabling people that are located remote from one another to communicate when travel is too time consuming or too expensive. Video telecommunication has the added benefit of allowing people to see each other via streaming video and provides a more intimate inter-personal connection between participants than audio communication alone.

Typically, video conferencing systems have not been designed for portability. Commonly, video conferencing systems utilize a personal computer, a separate camera, and often a separate microphone and speakers. Generally, one or more of these devices are powered by plugging them into an electrical outlet. Other video conferencing systems may be integrated into a single package, but are often large and bulky and are intended for use in a conference room and are not intended for transport beyond an office facility. Likewise, video conferencing systems have typically been designed for use on a device having a connection to a local area network (LAN). In order to use the video conferencing device, it generally must be configured to work with a LAN, which can be difficult for the novice user. Moreover, these devices cannot be used for video conferencing if a high-speed LAN is not available.

Some newer devices are portable but offer limited video conferencing capabilities. These devices often are not capable of true two-way video conferences. That is, the portable devices are typically not capable of streaming captured data from the device while simultaneously receiving streamed data at the device. Rather, although some portable devices may be bi-directional, they may only received streamed video, or send streaming video, but not at the same time. Moreover, the video on portable devices is typically low quality and generally cannot be controlled remotely.

### SUMMARY OF THE DISCLOSURE

In accordance to one aspect of the invention, a portable video conferencing device includes a mobile computing device, an audio device electrically linked to the mobile computing device, a video camera electrically linked to the mobile computing device, and at least one wireless radio chipset electrically linked to the mobile computing device. The video camera is operable to provide a video output stream and to execute commands received at the portable video conferencing device. The at least one wireless radio chipset enables the portable video conferencing device to stream video captured from the video camera over a wireless radio broadband network while the portable video conferencing device receives streaming video via the wireless radio broadband network.

According to another aspect of the invention, a portable video conferencing device includes a mobile computing device having a processor and memory, an audio device electrically linked to the mobile computing device, a video camera electrically linked to the mobile computing device, and a wireless radio modem. The video camera is operable to provide a video output stream and includes a web server to receive commands received by the portable video conferencing device. The wireless radio modem provides a connection to a wireless radio broadband network for the mobile computing device and the video camera. The portable video conferencing device streams audio and video from the video camera and the audio device via the wireless radio broadband network while receiving streaming audio and video via the wireless radio broadband network.

According to yet another aspect of the invention, portable video conferencing device includes a mobile computing device, an audio input device electrically linked to the mobile computing device, a video camera electrically linked to the mobile computing device, and a wireless transceiver. The video camera is operable to provide a video output stream and to execute commands received by the portable video conferencing device. The wireless transceiver provides a connection to a wireless network for the mobile computing device and the video camera. The portable video conferencing device also includes a remote control function to steam video from the video camera via the wireless network upon receipt of a remote control command at the portable video conferencing device via the wireless network.

### BRIEF DESCRIPTION OF THE DRAWINGS

Reference now is made to the accompanying drawings in which:

FIG. 1 is a block diagram depicting an exemplary embodiment of a wireless communication system;

FIG. 2 is a perspective view depicting an exemplary embodiment of a wireless communication device from the wireless communication system of FIG. 1; and

FIG. 3 is a block diagram of the wireless communication device as shown in FIG. 2.

### DETAILED DESCRIPTION

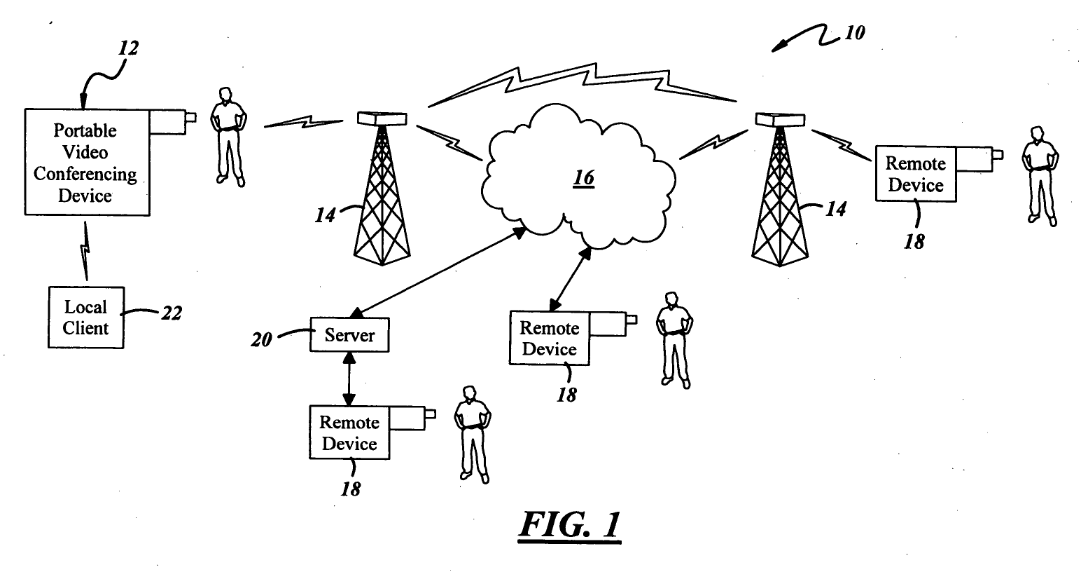

Beginning with FIG. 1, there is shown an exemplary operating environment that can be used for video conferencing. A communications system generally shown at 10 includes a portable video conferencing device 12, hereinafter referred to as portable communicator 12, capable of streaming audio and video through a wireless network 14, a land network 16, and one or more remote devices 18. It should be understood that the disclosed portable communicator 12 can be used with any number of different communication systems, and used to connect with any number of remote devices 18. Only three remote devices 18 are shown for simplicity of the drawing.

The portable communicator 12 may provide wireless portable audio and video communication with remote devices 18. The portable communicator 12 is configured to communicate via the wireless network 14 to stream audio and video without requiring a user to manually configure network settings for each location where the portable communicator is used. Moreover, the portable communicator 12 may stream audio and video captured at the portable communicator to one or more remote devices 18 and, at the same time, present streaming audio and video on the portable communicator received from the one or more remote devices 18.

In one implementation, portable communicator 12 uses radio transmissions to communicate with wireless network 14 in order to provide wireless voice and video communication services. Wireless network 14 provides wireless wide area broadband data services. For example, wireless network 14 can be a cellular telephone system 10 that provides wireless broadband data services, but could be any other suitable wireless broadband system 10. According to an exemplary embodiment, wireless network 14 can include one or more cell towers, base stations and/or mobile switching centers (MSCs), as well as any other networking components required to connect wireless network 14 with land network 16. According to an exemplary implementation, wireless network 14 is a CDMA wireless network 14 that provides wireless broadband data services such as a third generation (3G) or fourth generation (4G) wireless broadband. 3G broadband wireless networks may be implemented based on EVDO, EVDV, or other like protocols. Likewise, 4G broadband wireless networks may utilize the WiMAX (IEEE 802.16e-2005) wireless protocol, or any other comparable protocols. Likewise, other broadband wireless network protocols may be used, such as HSDPA, UMB, and the like. The cellular network may provide connections to land network 16 to enable portable communicator 12 to communicate with remote devices 18 linked to land network 16.

Land network 16 may be a conventional land-based telecommunications network that is connected to one or more landline networks and connects wireless network 14 to internet accessible devices, servers, and other services. For example, land network 16 may include a public switched telephone network (PSTN) and/or a TCP/IP network. Of course, one or more segments of land network 16 could be implemented with a wired landline network, a fiber or other optical network, a cable network, power lines, other wireless networks such as wireless local area networks (WLANs), or networks providing broadband wireless access (BWA), or any combination thereof.

One or more remote video conferencing devices 18 may connect to the wireless network 14 and/or the land network 16. The remote devices 18 may be video conferencing devices known in the art and may receive streaming audio and video from the portable communicator 12 via wireless network 14 and/or land network 16. In one alternative, the remote device 18 may be another portable communicator 12 and thus enable two or more portable devices to communicate from different locations via the wireless network 14.

In one implementation, remote device 18 may connect to the land network 16 via a remote server 20. The remote server 20 may provide one or more services to facilitate video conferencing between the portable communicator 12 and the remote device 18. For example, remote server 20 may provide an internet accessible website that allows support technicians to view the status of various portable communicators 12. Remote server 20 may also provide information related to a support request from portable communicator 12. In one example, portable communicator 12 connects to remote server 20. The remote server 20 may provide any number of services for portable communicator 12 as disclosed in U.S. patent application Ser. No. 11/581,826, filed Oct. 17, 2006 and herein incorporated by reference. Several Remote server 20 may also provide dynamic domain name system 10 (DDNS) services for portable communicators 12. Since portable communicator 12 may receive a dynamic IP address, remote server 20 may use DDNS to assist remote device 18 in locating a particular portable communicator 12. Remote server 20 may also provide a database (not shown) of remote devices 18. Such a database may contain details about each remote device 18 that may be helpful for locating an appropriate remote device 18 to communicate with the portable communicator 12. For example, the database may include broad identifiers about the area of expertise and experience level of technicians operating a remote device 18 used for providing technical support. The database may also be updated with availability info such that operator can search the database for available technicians that can provide appropriate assistance to users at the portable communicator 12.

The remote devices 18 may stream audio and video to the portable communicator 12 or to other remote devices 18. The audio and video may include presentations shared by the remote device 18 and/or captured audio and video using a microphone and camera located at the remote device 18. Remote device 18 may include a shared user interface that is visible at the portable communicator 12 to allow users at the portable communicator 12 to view the presentations. The user interface may also allow users at the portable communicator 12 to select items, such as presentations to view and control icons to control the camera at the remote device 18. Remote device 18 may also include a library of video presentations that may be streamed from the remote device 18 to the portable communicator 12. The library of video presentations may be stored locally on the remote device 18 or within a database accessible to the remote device. Video presentations may be selected locally at the remote device 18 for streaming to portable communicator 12, or may be selected at the portable communicator 12 via the shared user interface.

Optionally, the system 10 may include local clients 22 that connect to the portable communicator 12 through a local wireless link. The local clients 22 may include handheld devices, personal computers, or portable communicators 12 capable of communicating through 802.11x wireless protocols. In one implementation, the local clients 22 may receive audio and/or video from the portable communicator 12. In another embodiment, the portable communicator 12 provides access to the wireless network 14.

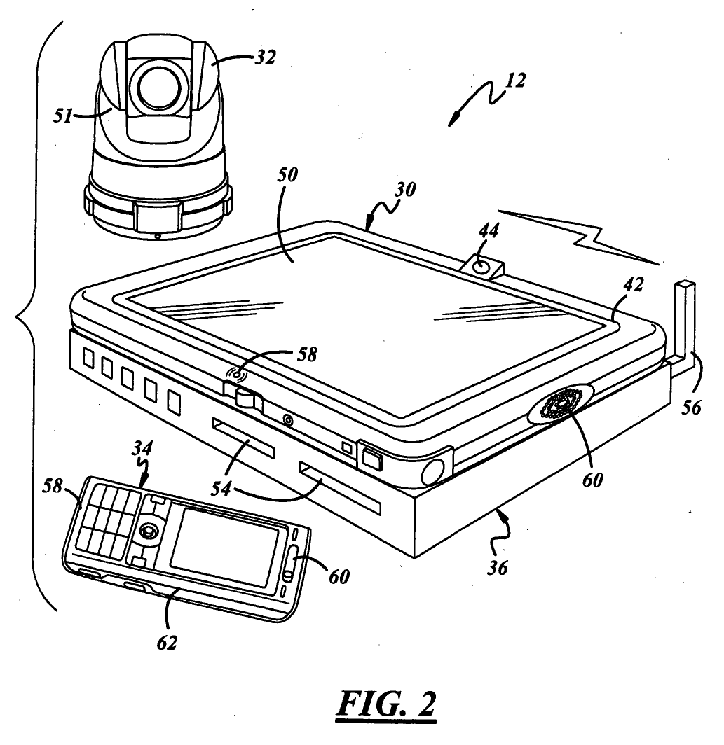

FIG. 2 illustrates one embodiment of portable communicator 12 for streaming video to remote devices 18 while receiving streaming video from the remote devices 18. Generally, portable communicator 12 includes a mobile computing device 30 for controlling the portable communicator 12, a video camera 32 for capturing live video, an audio device 34 for capturing sound, a wireless transceiver 36, and a power supply 38. Portable communicator 12 may also include additional devices such as a local server 40, a rugged case 42, and a secondary camera 44 to name but a few. Portable communicator 12 may be a single unit or it may also be composed of several electrically linked components that provide audio and video communication over the wireless network 14.

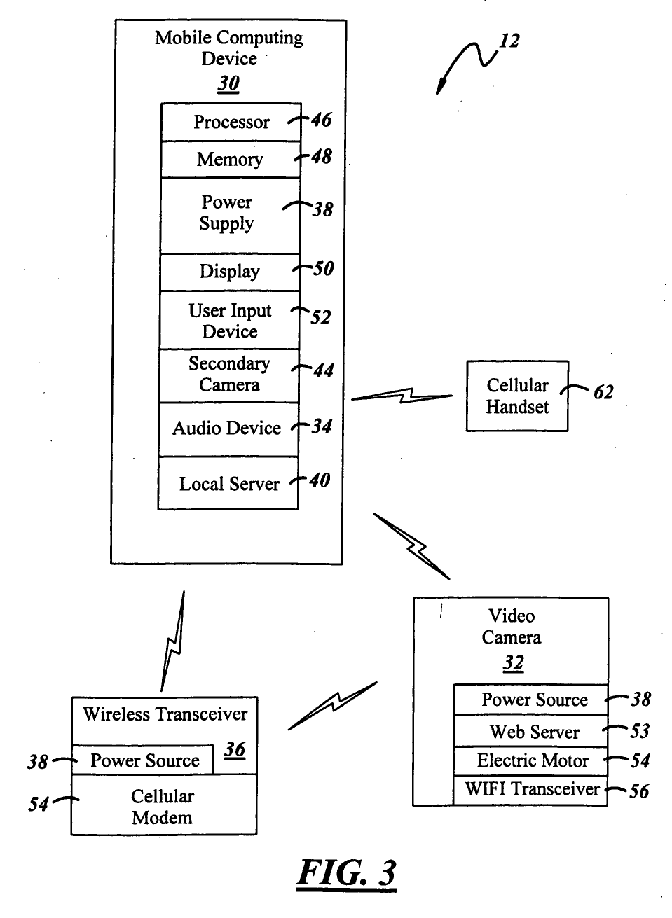

Mobile computing device 30 may provide for the execution of software code within portable communicator 12. The mobile computing device 30 may incorporate any number of portable computing form factors such as a laptop, tablet PC, PDA, mobile phone, and the like. As illustrated in FIG. 3, computing device 30 may include an electronic processing device 46, one or more types of electronic memory 48, a display 50, and an input device 52. Computing device 30 may also include communication ports (not shown) such as USB, fire wire, serial, parallel, PCMCIA, PCI, ISA, Bluetooth, and the like to enable devices to connect to the computing device 30. For example, the communication ports may enable the computing device 30 to connect to the video camera 32, input device 52, wireless transceiver 36, and the like. Computing device 30 may also include one or more multimedia ports (not shown) to provide output to one or more external video and audio devices, such as an external monitor or external speakers.

The processing device 46 may be any type of commercially available processing device including microprocessors, microcontrollers, host processors, controllers, and application specific integrated circuits (ASICs). The processing device 46 can execute various types of electronic instructions, such as software or firmware programs stored in the electronic memory 48. For instance, the processing device 46 can be used to execute programs or process data.

The memory 48 may be any type or types that provide for both long and short-term data and computer program storage. In one embodiment, computing device 30 includes RAM for short-term storage, and a hard disk for long-term storage.

Display 50 provides visual information at the portable communicator 12. The display 50 may be a video monitor, LCD screen, text only display, touch screen, or the like. The display 50 may be integrated into the mobile computing device 30 or may be an external display unit. The display 50 may enable a user to view a user interface that may include text and/or graphics processed by the computing device 30, such as video streaming to the portable communicator 12 from remote device 18 or a presentation being shared by remote device 18. Moreover, when the portable communicator 12 is enabled for two-way communication, the user interface may present video streamed from the remote device 18 to the portable communicator 12 while also displaying video captured by and streamed from the portable communicator 12. The user interface may provide a split screen to enable viewing of the captured video and the video received from one or more remote devices 18. The split screen may provide feedback to the user at the portable communicator 12 so that they can view the video streamed to the remote device 18 and verify that the camera is oriented to capture the desired subject matter while still seeing the video streamed from the remote devices 18 on the same screen.

The display 50 may also act as an input device 52. Providing a touch screen display 50 may allow users to select graphical items on a screen and may provide a virtual keyboard for users to enter text. The input device 52 need not be integrated into display 50, however, and any type of input device 52 may enable the user to interact with the portable communicator 12 and, in particular, the computing device 30. One or more input devices 52 may include keyboards, mouse, remote controls, touch screens, touch pads, voice recognition systems, and the like. Input devices 52 are electrically linked to the mobile computing device 30. Input devices 52 may be integrated into the mobile computing device 30 or may be linked via a communication protocol such as USB, serial bus, infrared, Bluetooth, and the like.

Video camera 32 provides a real-time video feed and is preferably a digital video system 10, such as a webcam or digital video camera 32. Video camera 32 may be integrated into computing device 30. Alternatively, video camera 32 may be an external device to provide more flexibility for positioning the camera to capture video of a desired scene. The video camera 32 may be electrically linked with the computing device 30 to enable the computing device to control the video camera. For example, the video camera 32 may be wirelessly connected to the computing device via a wireless protocol such as 802.11x or Bluetooth, hard wired to the computing device 30, or may be cabled to the computing device 30 via a USB, fire wire IEEE 1394 cable, or the like. In another alternative, computing device 30 may communicate with video camera 32 via connections between each device and wireless transceiver 36.

The video camera 32 may be a robotic webcam that includes features such as zoom, pan, and tilt that may be controlled by an external device. For example, video camera 32 may be a robotic webcam that includes an electric motor 51 for providing the pan and tilt functionality. Video camera 32 may also include an optical zoom lens and provide for digital zoom functionality. A handheld remote (not shown) may be used with the video camera 32 to provide users near the camera with the ability to control the camera.

The video camera 32 may also include its own web server 53 to handle communication and control of the video camera. The web server may provide a user interface for users at remote device 18 to interact with the camera. For example, the web server's user interface may enable users at remote devices 18 to control the zoom, pan, and tilt of the camera by manipulating controls on the user interface. In one alternative, the web server for the video camera 32 may be provided on the computing device 30 rather than the video camera 32 so that all communication between the portable communicator 12 and the remote device 18 is facilitated via the computing device 30.

Additionally, the video camera 32 may include a remote control function to enable an authorized user at a remote device 18 to send a remote control command to the portable communicator 12. The web server 53 may process the remote control function. Upon receipt of the remote control command at the web server from remote device 18, the control command may instruct the web server 53 on the video camera 32 to begin streaming video to the remote device 18. When a remote control command is received, the web server may process the control command and may verify whether the control command was sent by an authorized user. Once verified, the web server may activate the video camera 32 to begin streaming video to the remote device 18. The control function may be useful where a user at a remote device 18 wants to establish communication with a user at the portable communicator 12. Before sending a control command, the remote device 18 may send audio to the portable communicator 12 asking a user at the portable communicator 12 to respond. If no response is received at the remote device 18, the remote device may send the control command to the portable communicator 12, instructing the portable communicator 12 to begin streaming video if it is not already doing so. Upon receipt of the streaming video, the user at the remote device 18 can see whether anyone is present at the portable communicator 12.

To facilitate transmission of the control commands, audio, and video, wireless transceiver 36 may use radio transmissions to establish at least one communications channel (a voice channel and/or a data channel) with wireless network 14. The portable communicator 12 may offer both voice and data communication and enable a number of different services related to remote communication via the wireless transceiver 36. For example, portable communicator 12 may provide voice and data communication, voice over IP (VOIP), text-based instant messaging, SMS messaging, graphic display, presentation display, and other remote services sent and received via the wireless transceiver 36.

Wireless transceiver 36 may include a wireless modem 54 for data transmission over the wireless network 14. The wireless modem 54 may be comprised as a chipset within the wireless transceiver 36 or as a plug in card received by the wireless transceiver 36. The modem 54 may operate using any number of different standards or protocols for audio and/or video transmissions as discussed above in relation to the wireless network 14. For example, some protocols supported by the modem 54 may include EVDO, CDMA, TDMA, GPRS, EDGE, WiMAX, and the like. The modem 54 may include a broadband wireless radio chipset using a wireless radio broadband protocol for connecting to the internet. The wireless radio modem 54 enables the portable communicator 12 to send streaming video from the video camera 32 while receiving streaming video from one or more remote devices 18 via the wireless network 14. The modem 54 enables portable communicator 12 to wirelessly transmit and receive streaming audio and video, thus providing portability. Moreover, the modem 54 also allows a user of the portable communicator 12 to travel with and use the portable communicator 12 anywhere in the wireless network 14 without the need to configure or reconfigure network settings on the portable communicator. All that a user needs to do is obtain a signal from the wireless network 14 to obtain a broadband internet connection.

If the wireless transceiver 36 contains more than one wireless modems 54 or more than one radio chipset within the modem 54, the wireless transceiver 36 may perform load balancing of the streaming video and/or audio. Load balancing may enable the wireless transceiver 36 to coordinate the sending and receiving of streaming data between the different modems 54 or chipsets within the modem 54 based upon the amount of data being sent or received. For example, one wireless radio chipset may receive streaming video at the portable communicator 12 while another wireless radio chipset may transmit streaming video from the portable communicator 12. The load balancing may reduce and/or eliminate collisions of data packets from video sent from the portable communicator 12 with video received at the portable communicator 12 that would otherwise occur if only a single chipset is used. Multiple modems 54 or chipsets within a modem 54 may also provide redundancy for the transmission of data to and from the portable communicator 12. Having at least two modems 54 or chipsets may ensure that communication is not interrupted in the event that one of them loses communication with the wireless network 14 as may occur occasionally when using wireless radio networks.

In one implementation, the wireless transceiver 36 may be a router to provide one or more local area network (LAN) connections for the portable communicator 12. The LAN connections provide connectivity to the wireless network 14 via the wireless transceiver 36 for the computing device 30 and the video camera 32. For example, the wireless transceiver 36 may provide LAN connectivity, wireless (e.g. 802.11x) and/or wired (e.g. a category 5 internet cable), for computing device 30 and/or video camera 32. The router may also provide one or more connections for local clients 22. The wireless transceiver 36 may include a WIFI transceiver 56 to communicate wirelessly with the devices. The WIFI transceiver may also provide an alternate internet connection for the portable communicator 12 to a local WIFI hotspot. For example, the WIFI transceiver 56 may be used to obtain an internet connection when no wireless radio broadband network connection can be obtained, such as when the portable communicator 12 is located outside the coverage area of the wireless radio broadband network. Likewise, the wireless transceiver 36 may provide a port for connecting the wireless transceiver 36 to land network 16 via a cable when no wireless connection is available.

The portable communicator 12 may also include a local server 40 to enable remote devices 18 to connect to the portable communicator 12. The local server 40 may be implemented in hardware, software, or a combination of both and may be integrated into the computing device 30 or wireless transceiver 36. The local server 40 may cooperate with a domain name server (DNS) to enable clients to access the server using the server's domain name. Alternatively, the local server 40 may operate using dynamic DNS to enable the clients to access the portable communicator 12 even if the server's IP address changes. The local server 40 may include a firewall to authenticate clients requesting access to the portable communicator 12 and may deny access to unauthorized clients.

Portable communicator 12 provides voice communication with the aid of audio device 34. The audio device 34 may include an audio input device 58, such as a microphone and an audio output device 60 such as a speaker. Generally, audio input device 58 and audio output device 60 can be any suitable device capable of receiving/providing verbal or other auditory information through portable communicator 12. In one implementation, the audio input device 58 and the audio output device 60 are integrated into the computing device 30 as shown in FIG. 2. Likewise, the audio input device 58 and/or the audio output device 60 may be integrated into the video camera 30. Alternatively, audio input device 58 and audio output device 60 may be implemented as a microphone 58 and speaker 60 integrated into a common telephone handset. The handset may be electrically linked with the portable communicator 12 or wireless transceiver 36 via a wire or via a wireless protocol such as Bluetooth or FM radio signal.

The audio device 34 may capture audio from the user and stream the audio to the remote device 18 using voice over IP (VOIP) or by streaming the audio using any number of known audio streaming methods that can be implemented using a computing device 30 and an internet connection. Alternatively, the audio may be streamed via a cellular voice channel of the wireless network 14. Connectivity to a cellular voice channel may be provided by audio device 34 if the audio device 34 is a cellular handset 62 having its own cellular chipset. Likewise, the wireless transceiver 36 may provide connectivity to a cellular voice channel if chipset is enabled to communicate via a voice channel. Communicating the audio via a voice channel may alleviate the need for the wireless transceiver 36 to send and receive streaming audio with the video or via the wireless broadband network 14. By sending and receiving the audio via the voice channel rather than via the wireless broadband, the bandwidth of the broadband connection between the wireless transceiver 36 and the wireless network 14 can be optimized for streaming high quality video.

One or more power supplies 38 provide power for portable communicator 12. Although FIG. 2 shows each device having its own power supply 38, multiple devices may share a common power supply 38. For example, the computing device 30 and the wireless transceiver 36 may utilize a common power supply 38. Other devices, such as the video camera 32, may contain their own power supply 38 to enhance their portability. The power supply 38 may be an internal rechargeable battery that enables wireless communication without the need for external power while the portable communicator 12 is in use. Power supply 38 may include an AC/DC converter to enable the portable communicator 12 to receive power from an AC electrical outlet when available and to recharge the battery. Likewise, the power supply 38 may include an inverter to receive power from a DC power source, such as a cigar lighter in a vehicle.

An optional rugged case 42 may enhance portability of the portable communicator 12. The rugged case 42 may include at least one compartment (not shown) for storing one or more of the computing device 30, wireless transceiver 36, power supply 38, video camera 32, audio device 34, and the like. The case 42 may also include a hard exterior shell to protect components inside the compartment. The case may include a protective material such as foam or rubber to cushion the components. The protective material may be composed of an electrostatic resistant material to prevent electrostatic charge from building up inside the case. The case may carry the video camera 32 and may further include a motor driven swivel joint for receiving the video camera 32 and provide options for positioning the camera during pan and tilt operations.

Another optional component of the portable device is a secondary camera 44. The secondary camera 44 may be used to provide a secondary view for the remote devices 18, such as a secondary view of a project being worked on by the user of the portable communicator 12. The secondary camera 44 may be similar to video camera 32 and provide remote control functionality and pan, tilt, and/or zoom controls. Alternatively, the secondary camera 44 may be used to capture streaming video of the user of the portable communicator 12 as the user communicates with one or more remote devices 18. As such, the secondary camera 44 may be mounted on the computing device 30, such as on the display 50 or may be integrated into a portion of the computing device 30. In this example, the secondary camera 44 may be a simplified web camera because it would not require robotic control and zoom functionality for streaming video of the user.

In operation, the portable communicator 12 may be easily transported to practically any location the user desires. For example, the user may desire to use the portable communicator 12 to obtain assistance with an outdoor project, such as at a construction site. The rugged case 42 provides a convenient package for carrying the portable communicator 12. Moreover, the battery provides power for the portable communicator 12, thus eliminating the need (at least for the duration of the battery life) for electrical outlets to power the communicator. Once the communicator is at the desired location, the user can point the video camera 32 in the general area of interest and establish a connection to the wireless network 14 through the wireless transceiver 36. Because the portable communicator 12 utilizes a wireless radio network 14, the user does not have to configure the portable communicator 12 to work with a LAN. This eliminates the need for the user to modify LAN settings in the computing device 30, local or remote servers, or video camera 32, and avoids having to modify security settings. Once a connection is established, the portable communicator 12 is ready to stream audio and video to one or more remote devices 18.

One or more clients or remote devices 18 may connect to the portable communicator 12 through the internet. Generally, the remote device 18 may connect to the portable communicator 12 through a web interface provided by the local server 40. The portable communicator 12 may require authentication of the remote device 18 such as through a login and password, by verifying the IP address of the client 18, or the like. The portable communicator 12 enables the user to select an available remote device 18 for establishing a connection. The portable communicator 12 may connect to the remote device 18 directly, via local server 40, or via remote server 20. The remote server 20 may act as an intermediary, such as at a customer support call center, and connect the portable communicator 12 with a remote device 18 based upon the needs of the user at the portable communicator 12. For example, the remote server 20 may inquiry into the needs of the user at the portable communicator 12, and may connect the portable communicator 12 with an appropriate party.

Once connected, the remote device 18 may communicate with the user at the portable communicator 12 through one-way or two-way communication. During one-way communication the portable communicator 12 captures audio and video using the audio device 34 and the video camera 32, digitizes the audio and video, and streams the audio and video to the remote device 18. The remote device 18 may receive and present the audio the video in real time. During one-way communication, the remote device 18 does not provide audio or video for transmission to the portable communicator 12 while receiving streaming audio and video. But the remote device 18 may control the video camera 32 through the web interface. For example, the remote device 18 may control the pan, tilt, and/or zoom of the camera 32 in order to view the area near the portable communicator 12 and focus the camera on an area of interest. Likewise, the remote device 18 can send a control command to the portable communicator 12 to initiate the streaming of video from the portable communicator to the remote device. Alternatively, one-way communication can involve streaming audio and/or video from the remote client to the portable communicator 12, but not while the portable communicator 12 is streaming video to the remote device 18.

During two-way communication, the remote client may stream audio and/or video to the portable communicator 12 while the portable communicator 12 streams video to the remote device 18. Two-way audio communication may enable the user at the portable communicator 12 to have a conversation a user at the remote device 18 in real-time while viewing video streamed from the remote device. Two-way video communication may enable the user at the portable communicator 12 to view streaming video from the remote device 18, and at the same time, the remote device 18 may view video streaming from the portable communicator 12.

Other variations and modifications are possible without departing from the scope and spirit of the present invention as defined by the appended claims.

We claim:

1. A portable video conferencing device comprising:
a mobile computing device;
an audio device electrically linked to the mobile computing device;
a video camera electrically linked to the mobile computing device and operable to provide a video output stream and to execute commands received at the portable video conferencing device; and
at least one wireless radio chipset electrically linked to the mobile computing device;
wherein the at least one wireless radio chipset enables the portable video conferencing device to stream video captured from the video camera over a wireless radio broadband network while the portable video conferencing device receives streaming video via the wireless radio broadband network.

2. The portable video conferencing device of claim 1, further comprising the at least one wireless radio chipset including at least two wireless radio chipsets and the at least two wireless radio chipsets perform load balancing of the streaming video from the video camera and the received streaming video amongst the wireless radio chipsets.

3. The portable video conferencing device of claim 1, further comprising a WI-FI transceiver that provides local WI-FI connections for the mobile computing device.

4. The portable video conferencing device of claim 3, further comprising the at least one wireless radio chipset being a data card coupled to the router.

5. The portable video conferencing device of claim 3, further comprising a rugged case carrying the mobile computing device and the router.

6. The wireless communications device of claim 1, further comprising the video camera being motor driven to control the camera's field of view.

7. The wireless communications device of claim 1, further comprising the video camera being a web server to receive commands remotely for controlling the video camera.

8. The wireless communications device of claim 1, further comprising the video camera being electrically linked to the mobile computing device via a wireless communication protocol.

9. The portable video conferencing device of claim 1, further comprising a second video camera being carried by the mobile computing device.

10. A portable video conferencing device comprising:
a mobile computing device including a processor and memory;
an audio device electrically linked to the mobile computing device;
a video camera electrically linked to the mobile computing device and operable to provide a video output stream, the video camera including a web server to receive commands received by the portable video conferencing device; and
a wireless radio modem providing a connection to a wireless radio broadband network for the mobile computing device and the video camera;
wherein the portable video conferencing device streams audio and video from the video camera and the audio device via the wireless radio broadband network while receiving streaming audio and video via the wireless radio broadband network.

11. The portable video conferencing device of claim 1, further comprising the wireless radio modem including at least two wireless radio chipsets and the at least two wireless radio chipsets perform load balancing of the streaming audio and video from the portable video conferencing device and the received streaming audio and video amongst the wireless radio chipsets.

12. The portable video conferencing device of claim 1, further comprising a router that provides local wireless connections for the mobile computing device to the wireless radio broadband network.

13. The portable video conferencing device of claim 12, further comprising the at least one wireless radio modem being a data card coupled to the router.

14. The wireless communications device of claim 1, further comprising the video camera being motor driven to control the camera's pan and tilt.

15. The wireless communications device of claim 1, further comprises a battery coupled the video camera.

16. The wireless communications device of claim 1, further comprising the video camera being electrically linked to the mobile computing device via one or more of WIFI or Bluetooth.

17. The portable video conferencing device of claim 1, further comprising a second video camera, wherein the second video camera is carried by the mobile computing device.

18. A portable video conferencing device comprising:
a mobile computing device;
an audio input device electrically linked to the mobile computing device;
a video camera electrically linked to the mobile computing device and operable to provide a video output stream and to execute commands received by the portable video conferencing device; and
a wireless transceiver providing a connection to a wireless network for the mobile computing device and the video camera;
wherein the portable video conferencing device includes a remote control function to steam video from the video camera via the wireless network upon receipt of a remote control command at the portable video conferencing device via the wireless network.

19. The portable video conferencing device of claim 18, further comprising the video camera including a web server for receiving the remote control function via the wireless network.

20. The portable video conferencing device of claim 18, further comprising the wireless transceiver providing a connection to a wireless radio broadband network.
